(19) United States
(12) Patent Application Publication
(10) Pub. No.: US 2011/0271779 A1
(43) Pub. Date: Nov. 10, 2011

(54) Linear Actuator

(75) Inventor: Steven Phillip Corcoran, Cawood (GB)

(73) Assignee: CORCOST LIMITED, Cawood (GB)

(21) Appl. No.: 13/145,249

(22) PCT Filed: Feb. 12, 2010
(86) PCT No.: PCT/GB10/00261

§ 371 Date: Jul. 19, 2011

(30) Foreign Application Priority Data
Feb. 16, 2009 (GB) 0902436.5
Feb. 16, 2009 (GB) 0902445.6
Feb. 16, 2009 (GB) 0902446.4
Feb. 16, 2009 (GB) 0902448.0
Feb. 17, 2009 (GB) 0902618.8

(51) Int. Cl. F16H 25/20

(52) U.S. Cl. 74/89.23

(57) ABSTRACT

A linear actuator includes a leadscrew and a drive rod threadingly engaged with the leadscrew to permit longitudinal movement of the drive rod along its axis as the leadscrew rotates. A sheath is provided around the drive rod. A gear column is arranged generally coaxially with the axis of the leadscrew, the gear column including a gear through which drive can be applied to rotate the gear column. The gear column is connected to the leadscrew such that rotation of the gear column causes rotation of the leadscrew with respect to the drive rod to cause the drive rod to extend and/or retract.

### BACKGROUND OF THE INVENTION

The present invention relates to a linear actuator in which a drive rod is extendable from and retractable towards or into an actuator housing.

Conventionally, such linear actuators comprise an externally threaded leadscrew received within and threadingly engaged with an internal threaded bore of an elongate drive rod. The drive rod is held in a manner to prevent its rotation, whilst allowing longitudinal movement to allow the drive rod to extend from and be received within the actuator housing. The end of the leadscrew not within the drive rod is connected through a series of gears to a drive, such as a motor, which is typically provided at 90° to the axis of the drive rod and beyond the end of the leadscrew. Typically the actuator, the gearing between the motor and the leadscrew, the leadscrew and the drive rod are all included within a single casing to define a unitary component.

In the prior art arrangement, the overall size of the linear actuator is therefore greater than the length of the leadscrew and drive rod. Also, due to the requirement for a plurality of gears coupling the output of the motor to the leadscrew this transmission is liable to wear or damage which will affect the operation of the linear actuator, is expensive, complex and heavy. It is also difficult to change the gearing, for example in the event of wear or failure or where the properties of the transmission are required to be altered, and therefore the arrangements have a narrow range of operation reducing the adaptability and application of the linear actuators.

### SUMMARY OF THE INVENTION

According to the present invention, a linear actuator comprises:
a leadscrew rotatably mounted about its longitudinal axis and including a threaded portion;
a drive rod including a threaded portion threadingly engaged with the threaded portion of the leadscrew, the drive rod having an axis generally coincident with or parallel to the longitudinal axis of the leadscrew, and mounted to permit longitudinal movement along its axis and to allow relative rotation between the leadscrew and the drive rod;
a sheath provided around the drive rod; and,
a gear column arranged generally coaxially with the axis of the leadscrew, the gear column including a gear through which drive can be applied to rotate the gear column, and being connected to the leadscrew such that rotation of the gear column causes rotation of the leadscrew with respect to the drive rod to cause the drive rod to extend and/or retract.

With the arrangement of the present invention, the provision of a gear column to apply drive from an actuator or other drive means to the leadscrew to cause the relative rotation of the leadscrew with respect to the drive rod and thereby cause the extension or retraction of the drive rod enables a compact and versatile arrangement. In particular, the simple connection of the actuator to the drive column and thereby to the leadscrew gives flexibility in the positioning of the actuation with minimal components in the transmission between the actuator and the leadscrew which can, for example, reduce the overall size, weight, complexity and/or cost, and can enable easy replacement of components.

It is preferred that the gear column surrounds the sheath. This arrangement is particularly advantageous in that a drive, such as a motor, can be provided laterally positioned with respect to the leadscrew and drive rod. This allows the overall length of the linear actuator to be substantially similar to the length of the leadscrew and drive rod when the drive rod is retracted. This is in comparison to prior art arrangements in which the drive motor is located longitudinally of the leadscrew and drive rod. The actuator may extend generally parallel to the axis of the leadscrew, generally perpendicular to the axis of the leadscrew, or at any other desired angle. Further, the arrangement of the drive and associated gearing laterally of the leadscrew and drive rod enables easy access to the actuator and associated components easing the removal and/or replacement of these, and/or the addition of additional drive means. This may be assisted by providing the linear actuator within a casing including a removable portion for allowing access to the drive.

In an alternative example, the gear column may be provided longitudinally from the leadscrew. In this case, it is preferred that the drive and associated gearing is provided within the gear column. This allows easy access to the drive and any associated gearing, for example to assist removal and/or replacement of the drive, associated gearing and/or other components such as springs, power supplies, electronics or the like, whilst also minimising the overall size of the linear actuator since the gear column and drive occupy the same longitudinal space.

It is further preferred that the linear actuator includes additional actuation means that can be coupled to the gear column to provide additional drive to the leadscrew and this additional actuation could be provided internally or externally from the linear actuator.

It is further preferred that an energy storage means is provided, coupled to the gear column, such that the rotation of the gear column can be used to store and/or convert energy for use internally or externally to the linear actuator.

### BRIEF DESCRIPTION OF THE DRAWINGS

Examples of the present invention will be described by way of example only to the accompanying drawings, in which:

FIG. 1 shows a sectional view of a linear actuator according to an example of the present invention;

FIG. 2 shows a sectional view of an alternative linear actuator according to an example of the present invention;

FIG. 3 shows a sectional view of a pair of linear actuators according to an example of the present invention;

FIG. 4 shows a sectional view of a linear actuator according to an example of the present invention;

FIG. 5 shows a sectional view of a device including a linear actuator as shown in FIG. 1; and

FIG. 6 shows a sectional view of a linear actuator according to an example of the present invention.

### DETAILED DESCRIPTION

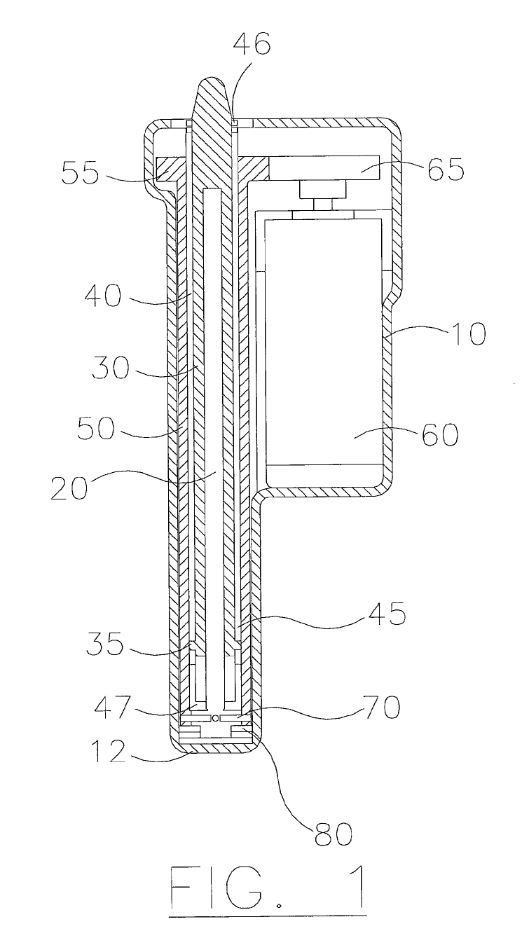

The linear actuator shown in FIG. 1 includes an externally threaded leadscrew 20 rotatably mounted for rotation about its longitudinal axis. The leadscrew 20 is received within a generally axial bore of a drive rod 30. The bore of the drive rod 30 has an internal thread that threadingly receives the external thread of the leadscrew 20. In use, the relative rotation of the leadscrew 20 with respect to the drive rod 30 causes the relative longitudinal movement between the leadscrew 20 and drive rod 30 to extend and retract the linear actuator.

The drive rod 30 is surrounded by and supported by a sheath 40. The sheath closely fits around the outside of the drive rod thereby preventing lateral movement of the drive rod within the linear actuator. However, the drive rod 30 may move axially within the sheath 40. The sheath 40 may include a low friction surface or coating to assist with the smooth and easy movement of the drive rod 30 within the sheath 40. Seals and/or bearings 46 are shown near the exit point of the sheath 40 to ensure the smooth movement of the drive rod 30 within the sheath 40 whilst preventing contamination passing into or out from the linear actuator.

As shown in FIG. 1, the drive rod 30 includes at least one projection 35 extending from the outer surface of the drive rod 30. The projection is received in an elongate channel 45 provided in the sheath 40. It will be appreciated that the channel 45 may be a slot formed through the sheath, a groove provided part way through the side wall of the sheath, or could be defined by projections on either side of a defined channel. The engagement of the projection 35 within the elongate channel 45 prevents the rotation of the leadscrew 20 within the sheath 40, whilst allowing the axial movement of the drive rod 30 within the sheath 40 by allowing the projection 35 to slide along the channel 45. It will be appreciated that any number of projections 35 and corresponding channels 45 may be provided, and that the elongate channel could instead be provided on the drive rod 30 with the projection being provided on the sheath 40. The drive rod 30 typically has a circular cross-section, but could have any other desired shape.

As will be appreciated, the rotation of the leadscrew 20 about its longitudinal axis, and the prevention of the rotation of the drive rod 30, will result in relative rotational movement between the leadscrew 20 and drive rod 30, causing relative longitudinal movement between the leadscrew 20 and the drive rod 30, causing the drive rod 30 to extend from or be retracted into the linear actuator.

As also shown in FIG. 1, the sheath 40 may extend beyond of the end of the drive rod 30 in its retracted position, and may include projections 47 which engage with the end of the leadscrew 20 to help avoid lateral movement of the internal end of the leadscrew 20. It would be appreciated that the projections 47 may bear directly against the leadscrew 20 or may include additional bearing components to ensure the smooth rotation of the leadscrew 20.

A generally tubular gear column 50 is shown provided around the sheath 40. An internal end of the gear column 50 is connected to the leadscrew 20, for example through connection pins or arms 70. It will be appreciated that the leadscrew 20 could be formed integrally with the gear column 50. The rotation of the gear column 50 about its longitudinal axis will therefore impart rotational movement to the leadscrew 20 through the connection 70. Suitable bearings 80 may be provided on the end of the gear column 50 and/or leadscrew 20 to permit the low friction and smooth rotation of the gear column 50 and leadscrew 20. The bearing may be sandwiched between the internal end of the gear column 50 and leadscrew 20, for example the collar at the end of the leadscrew 20 and a rear 12 of a casing 10 containing the linear actuator.

The gear column 50 also includes a gear 55 that meshes with a drive gear 65 that is in turn driven by a drive 60 such as an electric motor. In this way, the actuation of the drive 60 will drive the drive gear 65, the drive of which will be transmitted to the gear column 50 through the gear 55, which will in turn cause rotation of the leadscrew 20 through the connection of the gear column 50 to the leadscrew 20 via the connection 70. As described above, this rotation will cause the drive rod 30 to extend from or be retracted into the linear actuator. It will be appreciated that intermediate gears may be provided between the drive gear 65 and the gear 55 on the gear column 50. It will also be appreciated that whilst the gear 55 and actuator 60 are shown external to the gear column 50, if the gear column has a sufficient internal diameter, the gear 55 and actuator 60 may be provided within the gear column 50 between the sheath 40 and the inside of the gear column 50.

Whilst the gear 55 on the gear column 50 is shown at the bottom of the linear actuator in FIG. 1, it will be appreciated that the gear 55 could be provided at any position along the length of the linear actuator to engage with the drive gear 65. An advantage of providing the gear 55 in the location shown in FIG. 1 is that the gear column 50 extends along the length of the actuator and accordingly helps support and locate the upper components. Further, this assists with the compact design of the linear actuator as providing the gear 55 at one end of the linear actuator gives the area beside the linear actuator throughout the entire length of the linear actuator for inclusion of the driving components such as the drive 60. In particular, a small or large proportionality between the input and output force and motion can be achieved in a non-complex, space efficient manner.

Whilst FIG. 1 shows the components of the linear actuator being provided within a dedicated housing 10, it will be appreciated that the components of the linear actuator could be provided within another device or machine, and in this case the components may be housed within the casing of that device.

In the example shown in FIG. 1, the leadscrew 20 has an external thread, and is received within an internally threaded bore of the drive rod 30. However, it will be appreciated that this orientation could be reversed, with the leadscrew including an internally threaded bore that receives the drive rod having an externally threaded surface. In this case, it will be appreciated that the means for preventing the rotation of the drive rod could be provided at a position towards the exit of the drive rod from the actuator beyond the leadscrew. In this case, the means for preventing the rotation of the drive rod comprises a projection from the sheath or casing that is received within an elongate channel on the drive rod. Alternatively, the drive rod could have an axially extending annular opening defining a centrally located rod surrounded by the outside of the drive rod, the centrally located rod having an external thread to mesh with an internal thread on the leadscrew. In this case the means for preventing rotation of the drive rod can be as previously described with a projection located at any suitable position along the length of the drive rod or sheath to engage with an elongate channel on the other of the sheath and drive rod.

In one example where the actuator is provided within a casing 10, a portion of the casing may be removable to allow the easy exchange, removal or addition of the drive 60.

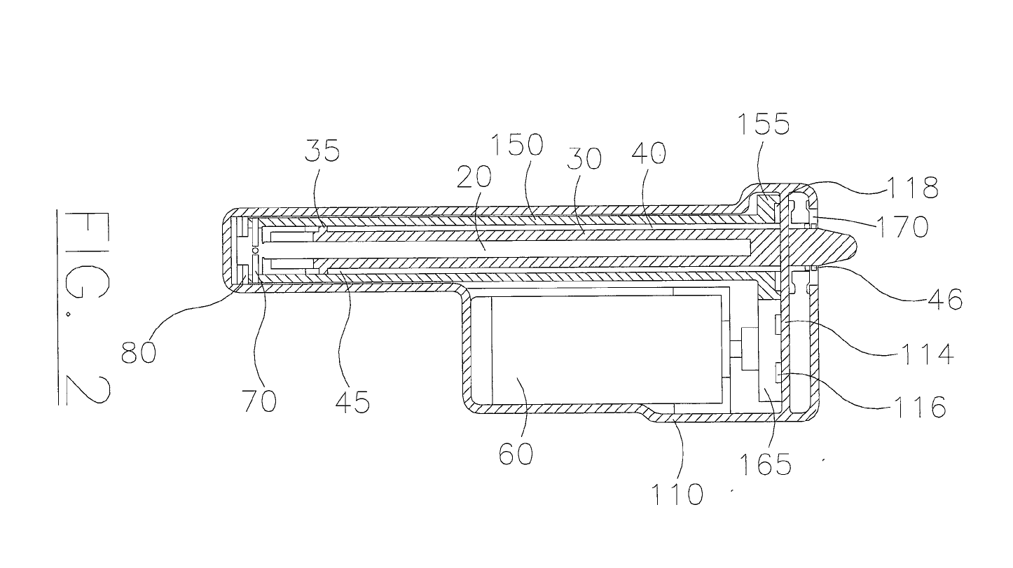

A variation of the linear actuator of FIG. 1 is shown in FIG. 2, where identical components have been given the same reference numbers. In this example, the drive gear 165 associated with the drive 60 and the gear 155 on the gear column 150 include bearings 116, 118 respectively which operate between a surface of the gears and a cross-member 114 of the casing 110. As well as providing a surface to support the drive gear 165 and gear 155 of the gear column 150, the cross-member can provide additional support for the components of the linear actuator and provide greater structural integrity to the casing including the top of the casing with the structural section 170 which can further allow force transfer to the base of the casing. In particular this support can help to prevent undesired longitudinal twisting or other movement of the components of the linear actuator within the casing as well as the casing itself.

In the example shown in FIG. 2, the linear actuator is mounted in support 180, such as a foot, to assist mounting to other components.

Whilst FIGS. 1 and 2 show a linear actuator having a single drive 60 driving the gear 55, 155 of the gear column 50, 150, through a single drive gear 65, 165, it will be appreciated that multiple actuators may be provided. In this case, the multiple actuators may operate through different drive gears that are both meshed with the gear on the gear column, or could act through separate gears on the gear column. The actuators may be internal or external to a casing containing the components of the linear actuator. The actuators may be mounted with the same or different orientations.

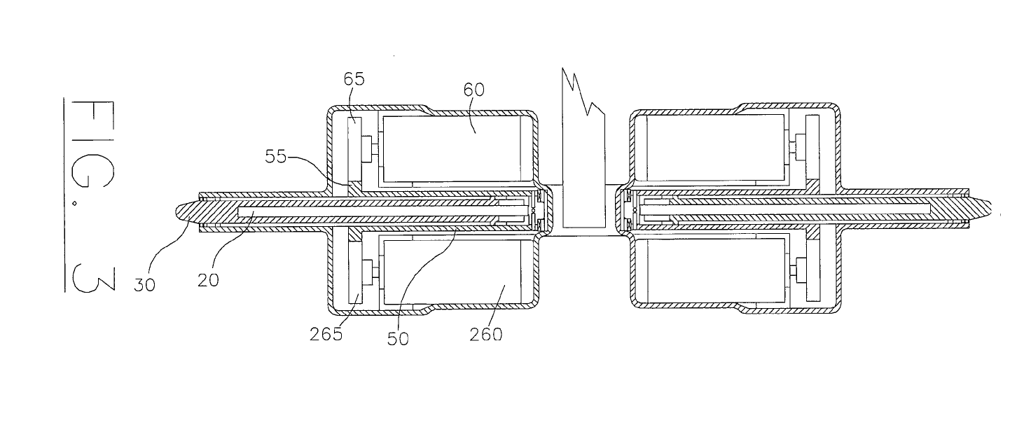

In FIG. 3, two linear actuators are shown arranged coaxially so that the respective drive rods extend in opposite directions, the linear actuators each including a first drive 60 with associated drive gear 65 driving the gear 55 on the gear column 50 and a second actuator 260 driving a second drive gear 265 to act on the gear 55 of the gear column 50. In this example, it will also be seen that the gear column 50 does not extend along the whole length of the linear actuator, but only along part of the length of the linear actuator such that the gear 55 on the gear column 50 is spaced from the end of the linear actuator. In this example, the linear actuators are identical, although it will be appreciated that these could have different features if required.

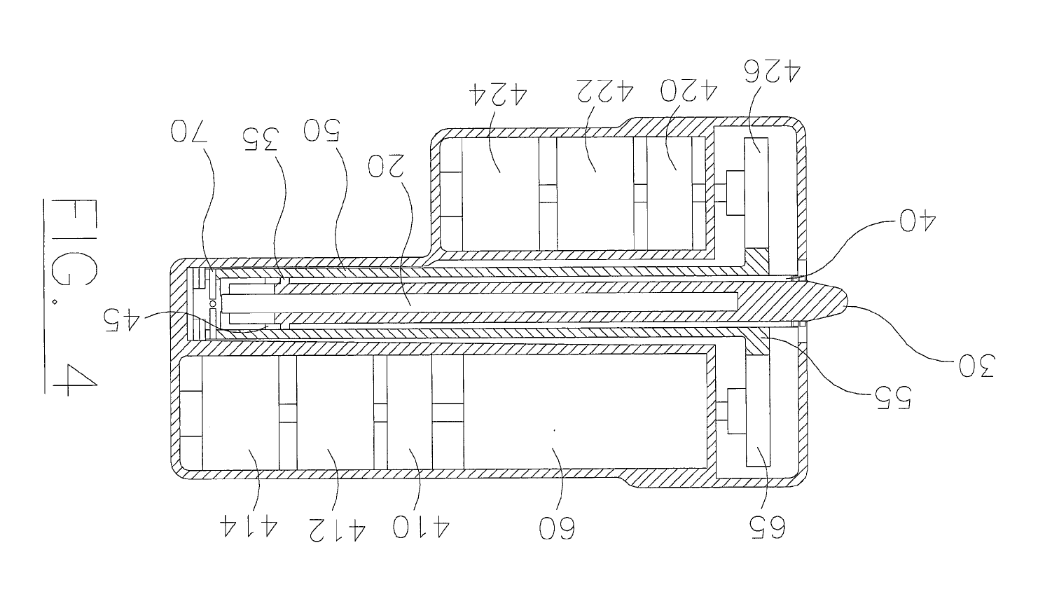

A further example of a linear actuator is shown in FIG. 4. In this example, the arrangement of the leadscrew 20, the drive rod 30, the sheath 40, the gear column 50, the gear 55 on the gear column 50, the connection of the gear column 50 to the leadscrew 20 via the connector 70, and the inclusion of the drive 60 for driving the drive gear 65 to cause the rotation of the gear column 50 are the same as described with respect to FIG. 1. However, additional components 410, 412, 414 are shown connected to the drive 60. Further components 420, 422, 424 are also shown connected to a second gear 426 meshed with the gear 55 on the gear column 50. The components 410, 412, 414, 420, 422, 424 can include any number of various types of component which may include, for example, additional actuators to supplement the drive power for driving the gear column 50, dynamos for converting energy from the rotation of the gear column 50 into electrical or other energy that can be stored, springs to store energy from the rotation of the gear column 50, and/or batteries for providing additional energy to assist with the driving of the linear actuator. In particular, it may sometimes be advantageous to provide additional power, for example during the initial or final movements of the linear actuator. In this case, any additional energy input, for example additional power to the drive 60 or additional actuators can be used to provide this additional power. In other cases, less energy may be required, or energy may be input to the system from an external source. For example, during a lowering operation, where the linear actuator is lowering a mass energy may be available that could be converted and stored, for example through a dynamo that is rotated by the rotation of the gear column 50. This energy could be converted into electrical energy that could be used outside the linear actuator, or could be stored, for example, in a spring, for use in the subsequent driving of the linear actuator. Where a dynamo is provided, this may include gearing for resistance being added to the movement and/or a spring type element such that the dynamo or other energy storage means such as a spring, operates only during part of the movement of the linear actuator, for example at the start and/or end of the movement. This may operated to slow the motion and in effect acting as an energy breaking/recovery element when the load is being slowed. Consequently this can provide a soft stop capability and/or assist with high load start up.

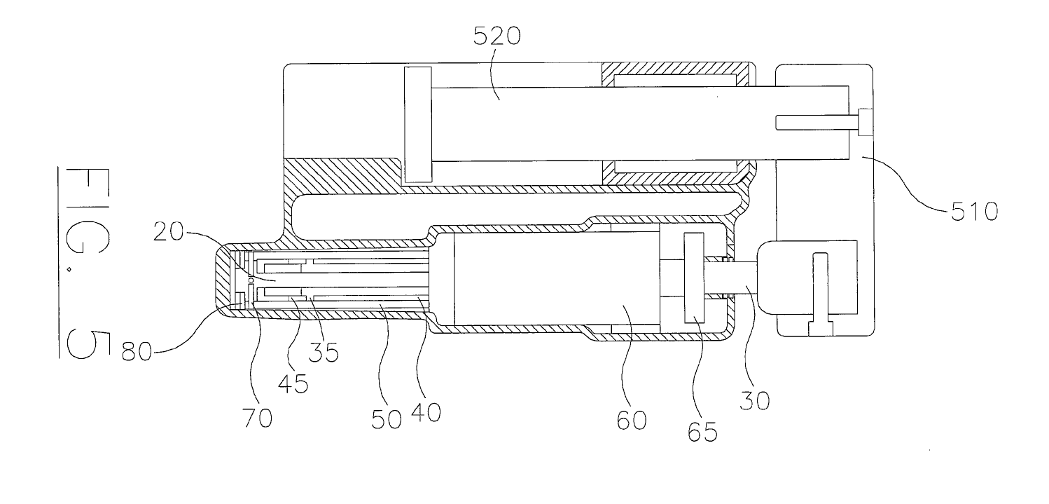

FIG. 5 shows a particular application for a linear actuator such as that shown in FIG. 1. In the figure, the lower portion corresponds to the linear actuator as shown in FIG. 1, and like reference numerals are used. The distal end of the drive rod 30 is shown attached to a component 510 which will be moved to the left and right as shown in the figure as the linear actuator is retracted and extended respectively.

In the example shown, the component 510 is also connected to a second elongate member 520 which extends generally parallel to the drive rod 30 and which is slideable along its axis generally parallel to the axis of the drive rod 30. The member 520 may be a telescopic member allowing this to freely extend. The provision of this second elongate member able to move generally parallel with the drive rod helps ensure the component 510 moves laterally without any undesired twisting or other movement.

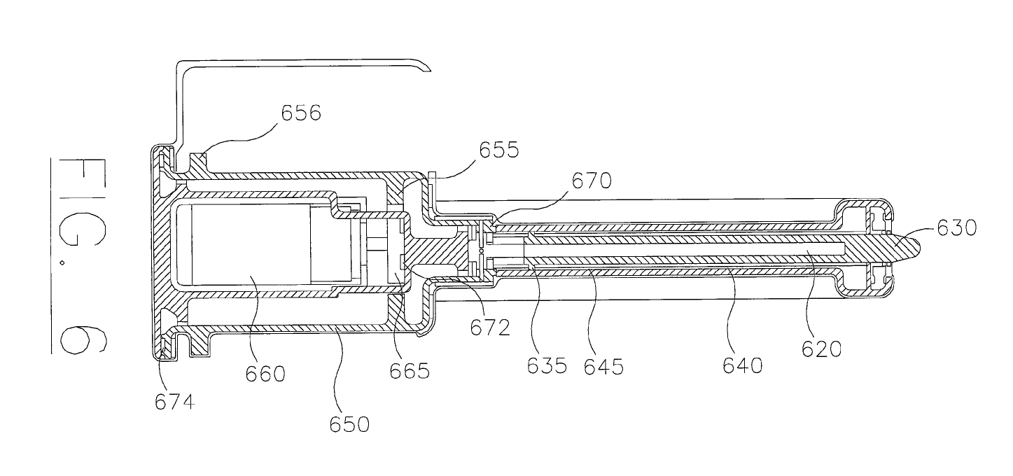

A further example of a linear actuator according to the present invention is shown in FIG. 6. Many of the features of the example of the linear actuator shown in FIGS. 1 to 5 are equally applicable to the linear actuator of FIG. 6, and for clarity these features are not being repeated here. As with FIG. 1, the actuator shown in FIG. 6 includes a rotatable leadscrew 620 having an external thread that is received within and engages with an internal threaded bore of a drive rod 630. The drive rod 630 is surrounded by a sheath 640, with a projection 635 provided on the external surface of the drive rod 630 that engages with an elongate channel 645 of the sheath 640 to allow the drive rod 630 to move longitudinally, but to prevent the rotation of the drive rod 630. A gear column 650 is provided, connected to the leadscrew 620 by a connection 670. Unlike the example described with respect to FIG. 1, the gear column 650 does not extend around the sheath 640, but extends away from the sheath 640. An actuator 660 is provided within the gear column 650, which can be a structural feature of the linear actuator. Bearings may be provided to assist with the rotation of the gear column 650. The actuator 650 can be provided within a casing which bears directly or indirectly against the leadscrew 620. This allows the easy removal of the casing, including the actuator 650 for simple change of the actuator 650 whilst also providing a structural feature of the linear actuator. In this example, the actuator 660 is connected to a drive gear 665 which engages with an internal gear 655 of the gear column 650 such that actuation of the actuator 660 rotates the drive gear 665 which in turn acts on the gear 655 to rotate the gear column 650, and thereby rotates the leadscrew 620. The drive gear 665 can feature bearings 672 as can the gear column 650 where the gear column bearings such as 674 can be distributed at relevant locations to allow the gear column to rotate with minimum friction and allow the gear column to transfer force to other components where necessary. As shown in FIG. 6, the actuator 660 is provided axially offset from the leadscrew 620, such that the drive 665 only engages with one part of the internal gear 655 of the gear column 650. It will, however, be appreciated that the actuator could be provided coaxially with the leadscrew 620. With this arrangement, it is easy to remove and replace the actuator and associated drive gear provided within the gear column 650, for example if an actuator having different power is required, or different gearing is required to vary the speed of actuation. Additional actuators may also be provided in the space if required. Further since the actuator can be provided within the gear column 650, the overall space occupied by the linear actuator can be minimised by comparison to the prior art in which a plurality of gears are used to couple to the leadscrew. Although not shown, additional components can be included within the space, for example energy storage and/or conversion means such as springs or dynamos as discussed previously, power sources such as batteries and any other components as desired.

As also shown in FIG. 6, the gear column 650 may include an external gear 656. This external gear may mesh with an external actuator to provide additional drive power to the gear column 650, or could be connected to a dynamo or energy storage means as described with respect to FIG. 4 to convert and/or store energy during certain operations of the linear actuator. Although not shown, additional components can be included within the space, for example energy storage and/or conversion means such as springs or dynamos as discussed previously, power sources such as batteries and any other components as desired.

1. A linear actuator comprising:
a leadscrew rotatably mounted about its longitudinal axis and including a threaded portion;
a drive rod including a threaded portion threadingly engaged with the threaded portion of the leadscrew, the drive rod having an axis generally coincident with or parallel to the longitudinal axis of the leadscrew, and mounted to permit longitudinal movement along its axis and to allow relative rotation between the leadscrew and the drive rod;
a sheath provided around the drive rod; and,
a gear column arranged generally coaxially with the axis of the leadscrew, the gear column including a gear through which drive can be applied to rotate the gear column, and being connected to the leadscrew such that rotation of the gear column causes rotation of the leadscrew with respect to the drive rod to cause the drive rod to extend and/or retract.

2. A linear actuator according to claim 1, further comprising a drive means to drive the gear column.

3. A linear actuator according to claim 2, in which the drive means comprises a motor.

4. A linear actuator according to claim 3, in which the motor is an electric motor.

5. A linear actuator according to claim 2, comprising a plurality of drive means that can be coupled to the gear column to provide additional drive to the leadscrew.

6. A linear actuator according to claim 2, in which the gear column surrounds the sheath.

7. A linear actuator according to claim 6, wherein the drive means is provided laterally of the leadscrew and drive rod.

8. A linear actuator according to claim 2, in which the gear column is provided longitudinally from the leadscrew.

9. A linear actuator according to claim 8, in which the drive is provided within the gear column.

10. A linear actuator according to claim 1, further comprising a housing or casing to house the leadscrew, drive rod, sheath and gear column.

11. A linear actuator according to claim 10, in which part of the housing or casing is removable to allow access to the components of the linear actuator.

12. A linear actuator according to claim 11, in which the opening in the housing or casing caused by the removal of the part is of a size to allow the linear actuator to pass through for removal or replacement.

13. A linear actuator according to claim 1, further comprising an energy storage means coupled to the gear column, such that the rotation of the gear column can store and/or convert energy from the rotation of the gear column for use internally or externally to the linear actuator.
